(19) United States
(12) Patent Application Publication
(10) Pub. No.: US 2019/0065373 A1
(43) Pub. Date: Feb. 28, 2019

(54) CACHE BUFFER

(71) Applicant: Micron Technology, Inc., Boise, ID (US)

(72) Inventors: Cagdas Dirik, Indianola, WA (US); Robert M. Walker, Raleigh, NC (US)

(21) Appl. No.: 15/690,442

(22) Filed: Aug. 30, 2017

(51) Int. Cl. G06F 12/0831; G06F 13/16

(52) U.S. Cl. CPC G06F 12/0831; G06F 12/0808; G06F 13/1626; G06F 13/1673

(57) ABSTRACT

The present disclosure includes apparatuses and methods related to a cache buffer. An example apparatus can store data associated with a request in one of a number of buffers and service a subsequent request for data associated with the request using the one of the number of buffers. The subsequent request can be serviced while the request is being serviced by the cache controller.

### TECHNICAL FIELD

The present disclosure relates generally to memory devices, and more particularly, to apparatuses and methods for a cache buffer.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

Memory can be part of a memory module (e.g., a dual in-line memory module (DIMM)) used in computing devices. Memory modules can include volatile, such as DRAM, for example, and/or non-volatile memory, such as Flash memory or RRAM, for example. The DIMMs can be using a main memory in computing systems.

### BRIEF DESCRIPTION OF THE DRAWINGS

FIG. 1 is a block diagram of a computing system including an apparatus in the form of a host and an apparatus in the form of memory system in accordance with one or more embodiments of the present disclosure.

FIG. 2 is a block diagram of an apparatus in the form of a memory system in accordance with a number of embodiments of the present disclosure.

FIG. 3 is a flow diagram of a request serviced by a buffer receiving data from a cache in accordance with a number of embodiments of the present disclosure.

FIG. 4 is a flow diagram of a number of requests serviced by a number of buffers in accordance with a number of embodiments of the present disclosure.

FIG. 5 is a flow diagram of a request serviced by a buffer receiving data from a memory device in accordance with a number of embodiments of the present disclosure.

### DETAILED DESCRIPTION

The present disclosure includes apparatuses and methods related to a cache buffer. An example apparatus can store data associated with a first request in a particular one of a number of buffers and service a subsequent, second request for data associated with the request using the particular one of the number of buffers.

In a number of embodiments, a number of buffers can be allocated to service requests and/or subsequent requests that are associated with data allocated to a particular buffer. The number of buffers can be searchable by the cache controller, so that data associated with a subsequent request can be located in a buffer and the subsequent request can be serviced using the buffer. Servicing a request using searchable buffers allows the cache line where the data in the buffer was located to not be locked while servicing a request that moves the data from the cache line to the buffer.

Also, buffers that are allocated to service a request can be masked so the masked buffers are not accessible when servicing subsequent requests. Buffers can be masked in response to receiving requests associated with data that is to be written to a cache line from which data was evicted and stored in the buffers that are being masked.

In a number of embodiments, using searchable buffers can allow the number of buffers to service requests to scale along with the size of the cache. Therefore, performance of the cache using searchable buffer is independent of the size of the cache.

In a number of embodiments, a cache controller can store data associated with a first request in a particular one of the number of buffers and service a subsequent (e.g., a second) request for data associated with the first request using the particular one of the number of buffers. The subsequent request is serviced while the first request is being serviced. The requests and/or subsequent request can evict data from the cache, read data from a buffer and/or cache, and/or write data to a buffer and/or cache. The buffers can be searchable, via a search algorithm performed with software, firmware, and/or hardware, to identify a block of number associated with data that is stored in the buffer.

In a number of embodiments, the cache controller can store data associated with an initial request in a first buffer and service a first subsequent request for data using another (e.g., a second) buffer and service a second subsequent request using the second buffer. The first buffer with data associated with the initial buffer can be masked while servicing the first subsequent request and the second subsequent request. The first subsequent request can write data to the cache where the data associated with the initial request was evicted. The second subsequent request can be serviced while the initial request and the first subsequent request are being serviced. Data associated with the second subsequent request can be located in another (e.g., second) buffer, which also includes data associated with the first subsequent request, using a linked list structure.

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and/or structural changes may be made without departing from the scope of the present disclosure. As used herein, the designators “X” and “Y”, particularly with respect to reference numerals in the drawings, indicates that a number of the particular feature so designated can be included. As used herein, “a number of” a particular thing can refer to one or more of such things (e.g., a number of memory devices can refer to one or more memory devices).

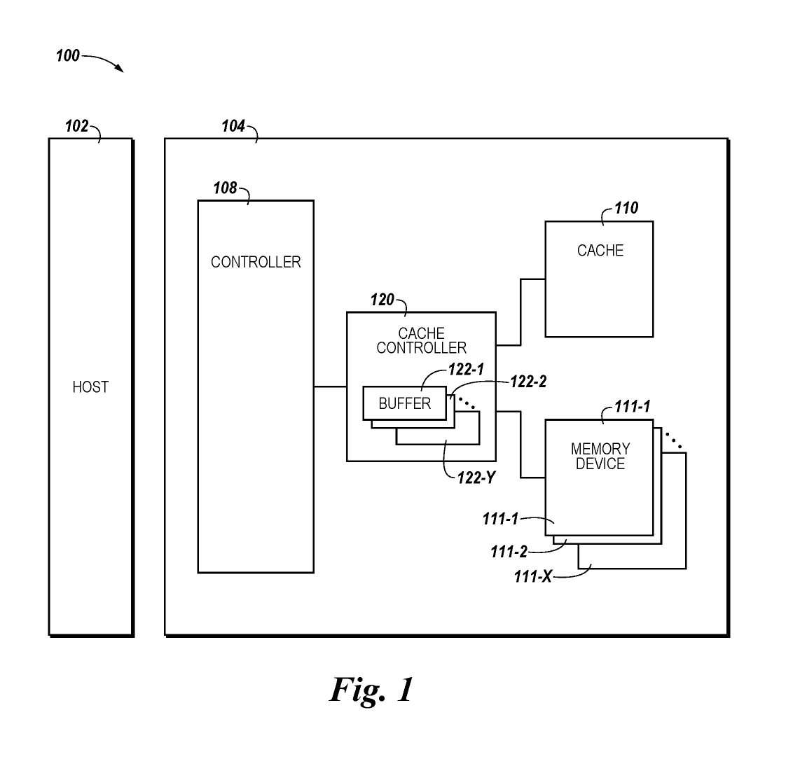

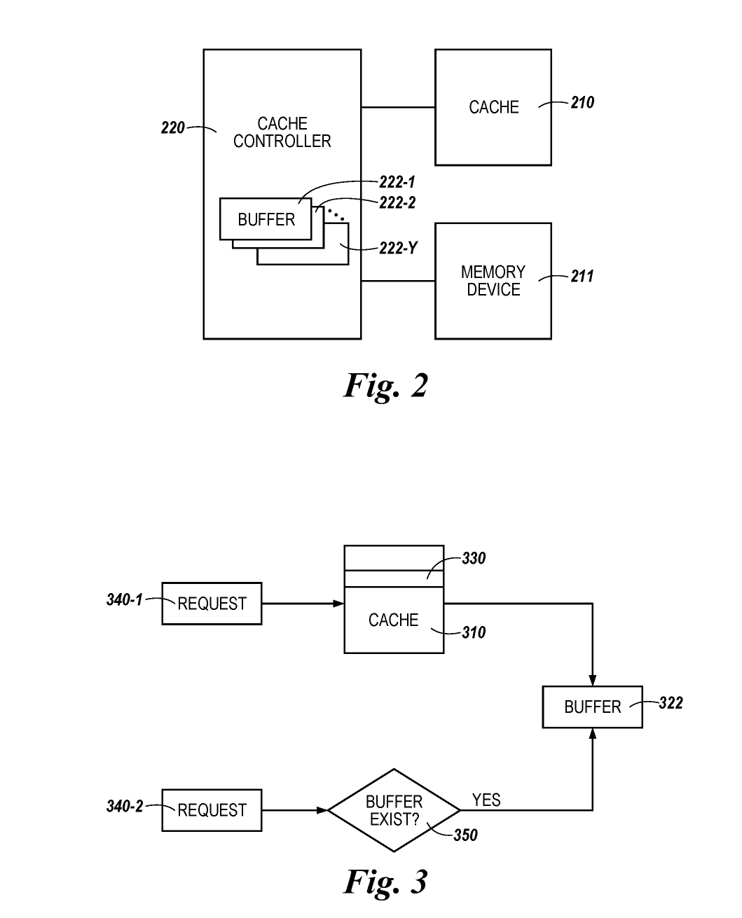

The figures herein follow a numbering convention in which the first digit or digits correspond to the drawing figure number and the remaining digits identify an element or component in the drawing. Similar elements or components between different figures may be identified by the use of similar digits. For example, 120 may reference element “20” in FIG. 1, and a similar element may be referenced as 220 in FIG. 2. As will be appreciated, elements shown in the various embodiments herein can be added, exchanged, and/or eliminated so as to provide a number of additional embodiments of the present disclosure.

FIG. 1 is a functional block diagram of a computing system 100 including an apparatus in the form of a host 102 and an apparatus in the form of memory system 104, in accordance with one or more embodiments of the present disclosure. As used herein, an “apparatus” can refer to, but is not limited to, any of a variety of structures or combinations of structures, such as a circuit or circuitry, a die or dice, a module or modules, a device or devices, or a system or systems, for example. In the embodiment illustrated in FIG. 1A, memory system 104 can include a controller 108, a cache controller 120, cache 110, and a number of memory devices 111-1, . . . , 111-X. The cache 120 and/or memory devices 111-1, . . . , 111-X can include volatile memory and/or non-volatile memory. The cache 110 and/or cache controller 120 can be located on a host, on a controller, and/or on a memory device, among other locations.

As illustrated in FIG. 1, host 102 can be coupled to the memory system 104. In a number of embodiments, memory system 104 can be coupled to host 102 via a channel. Host 102 can be a laptop computer, personal computers, digital camera, digital recording and playback device, mobile telephone, PDA, memory card reader, interface hub, among other host systems, and can include a memory access device, e.g., a processor. One of ordinary skill in the art will appreciate that “a processor” can intend one or more processors, such as a parallel processing system, a number of coprocessors, etc.

Host 102 can includes a host controller to communicate with memory system 104. The host 102 can send requests that include commands to the memory system 104 via a channel. The host 102 can communicate with memory system 104 and/or the controller 108 on memory system 104 to read, write, and erase data, among other operations. A physical host interface can provide an interface for passing control, address, data, and other signals between the memory system 104 and host 102 having compatible receptors for the physical host interface. The signals can be communicated between host 102 and memory system 104 on a number of buses, such as a data bus and/or an address bus, for example, via channels.

Controller 108, a host controller, a controller on cache 110, and/or a controller on a memory device can include control circuitry, e.g., hardware, firmware, and/or software. In one or more embodiments, controller 108, a host controller, a controller on cache 110, and/or a controller on a memory device can be an application specific integrated circuit (ASIC) coupled to a printed circuit board including a physical interface. Memory system can include cache controller 120 and cache 110. Cache controller 120 and cache 110 can be used to buffer and/or cache data that is used during execution of read commands and/or write commands.

Cache controller 120 can include a number of buffers 122-1, . . . , 122-Y. Buffers 122-1, . . . , 122-Y can includes a number of arrays of volatile memory (e.g., SRAM). Buffers 122-1, . . . , 122-Y can be configured to store signals, address signals (e.g., read and/or write commands), and/or data (e.g., metadata and/or write data). Buffers 122-1, . . . , 122-Y can temporarily store signals and/or data while commands are executed. Cache 110 can include arrays of memory cells (e.g., DRAM memory cells) that are used as cache and can be configured to store data that is also stored in a memory device. The data stored in cache and in the memory device is addressed by the controller and can located in cache and/or the memory device during execution of a command.

Memory devices 111-1, . . . , 111-X can provide main memory for the memory system or could be used as additional memory or storage throughout the memory system 104. Each memory device 111-1, . . . , 111-X can include one or more arrays of memory cells, e.g., non-volatile and/or volatile memory cells. The arrays can be flash arrays with a NAND architecture, for example. Embodiments are not limited to a particular type of memory device. For instance, the memory device can include RAM, ROM, DRAM, SDRAM, PCRAM, RRAM, and flash memory, among others.

The embodiment of FIG. 1 can include additional circuitry that is not illustrated so as not to obscure embodiments of the present disclosure. For example, the memory system 104 can include address circuitry to latch address signals provided over I/O connections through I/O circuitry. Address signals can be received and decoded by a row decoder and a column decoder to access the memory devices 111-1, . . . , 111-X. It will be appreciated by those skilled in the art that the number of address input connections can depend on the density and architecture of the memory devices 111-1, . . . , 111-X.

FIG. 2 is a block diagram of an apparatus in the form of a memory system in accordance with a number of embodiments of the present disclosure. In FIG. 2, the memory system can be configured to cache data and service requests from a host and/or memory system controller. The memory system can include cache controller 220 with a number of buffers 222-1, . . . , 222-Y. buffers 222-1, . . . , 222-Y can include SRAM memory, for example. Buffers 222-1, . . . , 222-Y can include information about the data in cache 210, including metadata and/or address information for the data in the cache. The memory system can include a memory device 211 coupled to the cache controller 220. Memory device 211 can include non-volatile memory arrays and/or volatile memory arrays and can serve as the backing store for the memory system.

Memory device 211 can include a controller and/or control circuitry (e.g., hardware, firmware, and/or software) which can be used to execute commands on the memory device 211. The control circuitry can receive commands from a memory system controller and or cache controller 220. The control circuitry can be configured to execute commands to read and/or write data in the memory device 211.

FIG. 3 is a flow diagram of a request serviced by a buffer receiving data from a cache in accordance with a number of embodiments of the present disclosure. In FIG. 3, a cache controller, such as cache controller 120 in FIG. 1, can receive request 340-1. Request 340-1 can cause data 330 to be evicted from a cache line in cache 310. While evicting data 330 from the cache line in cache 310 to a memory device, buffer 322 can be allocated to store data 330. Buffer 322 can store data 330 and can be searchable by the cache controller when performing subsequent requests. Also, the cache line in cache 310 that stored data 330 is not locked while data 330 is being evicted from cache 310.

The cache controller can receive request 340-2 subsequent to request 340-1 and while request 340-1 is being serviced. Request 340-2 can be serviced while request 340-1 is being serviced via the use of buffer 322 that is searchable by the cache controller. For example, requests for the data 330 that is being evicted from cache 310 while servicing request 340-1 can be serviced via buffer 322.

In a number of embodiments, request 340-2 can be a read command requesting data 330. Request 340-2 can be received by the cache controller while request 340-1 is being serviced and evicted data 330 from cache 310. While servicing request 340-1, buffer 322 can be allocated to data 330, buffer 322 can be searchable by the cache controller, and data 330 can be moved to buffer 322. Request 340-2 can be serviced by the cache controller searching buffers to determine if a buffer with data 330 exists 350. In response to determining that data 330 associated with request 340-2 is in buffer 322, request 340-2 can be serviced by returning data 330 from buffer 322.

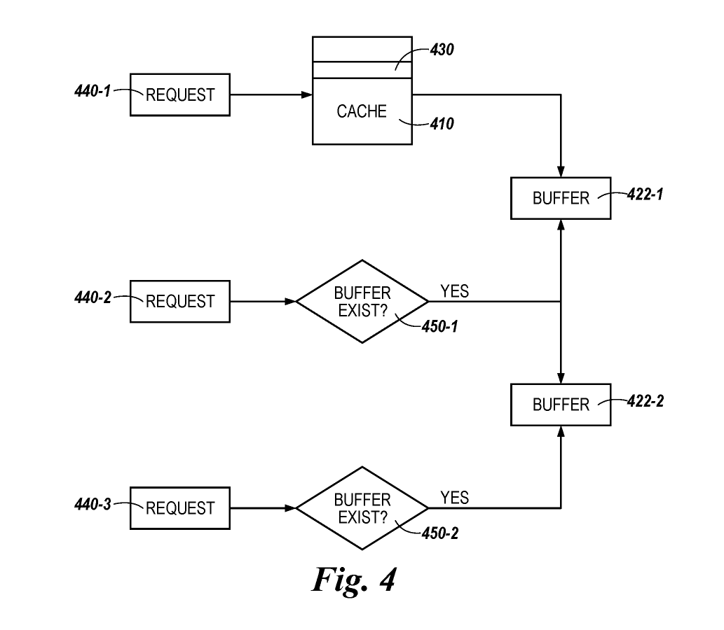

FIG. 4 is a flow diagram of a number of requests serviced by a number of buffers in accordance with a number of embodiments of the present disclosure. In FIG. 4, a cache controller, such as cache controller 120 in FIG. 1, can receive request 440-1. Request 440-1 can cause data 430 to be evicted from a cache line in cache 410. While evicting data 430 from the cache line in cache 410 to a memory device, buffer 422-1 can be allocated to store data 430. Buffer 422-1 can store data 430 and can be searchable by the cache controller when performing subsequent requests. Also, the cache line in cache 410 that stored data 430 is not locked while data 430 is being evicted from cache 410.

The cache controller can receive request 440-2 subsequent to request 440-1 and while request 440-1 is being serviced. Request 440-2 can be serviced while request 440-1 is being serviced via the use of buffer 422-1 that is searchable by the cache controller. For example, request 440-2 can be a write command to write data to the cache line in cache 410 where data 430 is being evicted. The cache controller can determine that buffer 422-1 includes data 430 that is being evicted from the cache line in cache 410 where data associated with request 440-2 will be written 450-1. In response to determining that buffer 422-1 includes data 430 that is being evicted from the cache line in cache 410 where data associated with request 440-2 will be written, buffer 422-1 can be masked so that data 430 in buffer 422-1 cannot be used by subsequent requests.

Request 440-2 can continue to be serviced by allocating buffer 422-2 for data associated with request 440-2 in response to determining that buffer 422-1 includes data 430 that is being evicted from the cache line in cache 410 where data associated with request 440-2 will be written 450-1. Data associated with request 440-2 can be written to buffer 422-2 while request is being serviced, where request 440-2 writes data to the cache line in cache 410.

The cache controller can receive request 440-3 subsequent to request 440-2 and request 440-1 and while request 440-2 and/or request 440-1 are being serviced. Request 440-3 can be serviced while request 440-2 and/or request 440-1 are being serviced via the use of buffer 422-2 that is searchable by the cache controller. In a number of embodiments, request 440-3 can be a read command requesting data associated with request 440-2. Request 440-3 can be received by the cache controller while request 440-2 is being serviced by writing data to cache 410. While servicing request 440-2, buffer 422-2 can be allocated to the data associated with request 440-2. Buffer 422-2 can be searchable by the cache controller and data associated with request 440-2 can be written to buffer 422-2 while servicing request 440-2. Request 440-3 can be serviced by the cache controller searching buffers to determine if a buffer with data associated with request 440-3 exists 450-2. In response to determining that data associated with request 440-3 is in buffer 422-2, request 440-3 can be serviced by returning data from buffer 422-2.

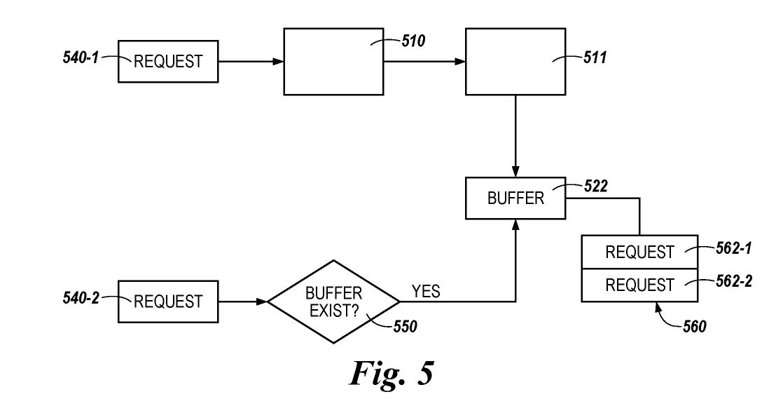

FIG. 5 is a flow diagram of a request serviced by a buffer receiving data from a memory device in accordance with a number of embodiments of the present disclosure. In FIG. 5, a cache controller, such as cache controller 120 in FIG. 1, can receive request 540-1. Request 540-1 can be a read command where the request 540-1 is a cache miss, so that data associated with request 540-1 is not located in cache 510. Request 540-1 can be serviced by allocating buffer 522 to the data associated with request 540-1 and locating the data associated with request 540-1 in a memory device 511. Buffer 522 can be searchable by the cache controller when performing subsequent requests. While data associated with request 540-1 is being retrieved from memory device 511, linked list structure 560 can include a dependency list that includes a number of entries, such as an entry 562-1. Entry 562-1 in linked list structure 560 can indicate that the data in buffer 522 is associated with request 540-1. Therefore, once the data is retrieved from memory device 511 and stored in buffer 522, the entry 562-1 in linked list structure 560 can cause request 540-1 to be serviced by returning the data from buffer 522.

The cache controller can receive request 540-2 subsequent to request 540-1 and while request 540-1 is being serviced. Request 540-2 can be serviced while request 540-1 is being serviced via the use of buffer 522 and linked list structure 560 that is searchable by the cache controller. Request 540-2 can be serviced by determining that buffer allocated to data associated with request 540-2 exists 550. In response to determining that buffer 522 is allocated to data associated with request 540-2, entry 562-2 in linked list structure 560 can indicate that the data in buffer 522 is associated with request 540-2. Therefore, once the data is retrieved from memory device 511 and stored in buffer 522, the entry 562-2 in linked list structure 560 can cause request 540-2 to be serviced by returning the data from buffer 522.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a cache controller; and
a cache and a memory device coupled to the cache controller, wherein the cache controller includes a number of buffers and wherein the cache controller configured to:
store data associated with a request in one of the number of buffers and service a subsequent request for data associated with the request using the one of the number of buffers.

2. The apparatus of claim 1, wherein the subsequent request is serviced while the request is being serviced.

3. The apparatus of claim 1, wherein the request evicts data from the cache.

4. The apparatus of claim 1, wherein the subsequent request reads data from the buffer.

5. The apparatus of claim 1, wherein data is kept in buffer until the request is serviced.

6. The apparatus of claim 1, wherein the data is located by searching the buffer.

7. The apparatus of claim 1, wherein cache line is not locked and the subsequent request does not wait for lock release before servicing the subsequent request.

8. An apparatus, comprising:
a cache controller; and
a cache and a memory device coupled to the cache controller, wherein the cache controller includes a number of buffers and wherein the cache controller configured to:
store data associated with a request in one of the number of buffers and service a first subsequent request for data associated with the first subsequent request using another one of the number of buffers and service a second subsequent request using the another one of the number of buffers.

9. The apparatus of claim 8, wherein the one of the number of buffers is masked while servicing the first subsequent request and the second subsequent request.

10. The apparatus of claim 8, wherein the request evicts data from the cache to the memory device.

11. The apparatus of claim 8, wherein the first subsequent request writes data to the cache where the data associated with the request was evicted.

12. The apparatus of claim 8, wherein the second subsequent request is serviced while the request and the first subsequent requests are being serviced.

13. The apparatus of claim 8, wherein the second subsequent request locates data in the another buffer using a linked list structure.

14. An apparatus, comprising:
a cache controller; and
a cache and a memory device coupled to the cache controller, wherein the cache controller includes a number of buffers and wherein the cache controller configured to:
service a request by storing data from the memory device in one of the number of buffers and service a first subsequent request for data associated with the request using the one of the number of buffers.

15. The apparatus of claim 14, wherein the request and first subsequent request are serviced in response to data being stored from the memory device to the one of the number of buffers.

16. The apparatus of claim 14, wherein the first subsequent request is received prior to data being stored in the one of the number of buffers.

17. The apparatus of claim 14, the first subsequent request is added to a dependency list for the one of number of buffer in a linked list structure.

18. The apparatus of claim 14, wherein the data from the number of buffers is stored in the cache to complete service of the request.

19. The apparatus of claim 14, a second subsequent request is serviced using the one of the number of buffers while the first subsequent request is being serviced.

20. A method, comprising:
receiving a request for data at a cache controller;
servicing the request by sending data stored in a buffer on the cache controller to a host, wherein the data stored in the buffer is associated with a previously received request.

21. The method of claim 20, further including servicing the previously received request while servicing the request.

22. The method of claim 20, further including servicing the previously received request by storing data from cache in the buffer and storing the data in the buffer to a backing store.

23. The method of claim 20, wherein servicing the request includes executing a read request for data with an address corresponding to the request.

24. A method, comprising:
receiving a request for data at a cache controller;
storing data associated with the request in one of a number of buffers and service a first subsequent request for data associated with the request using another one of the number of buffers and service a second subsequent request using the another one of the number of buffers.

25. The method of claim 24, wherein the method includes masking the one of the number of buffers while servicing the first subsequent request and the second subsequent request.

26. The method of claim 24, wherein the method includes evicting data from a cache to the memory device.

27. The method of claim 24, wherein the method includes writing data to a cache where the data associated with the request was evicted.

28. The method of claim 24, wherein the method includes servicing the second subsequent request while the request and the first subsequent request are being serviced.

29. The method of claim 24, wherein the method includes servicing the second subsequent request by locating data in the another buffer using a linked list structure.
